(19) United States
(12) Patent Application Publication
(10) Pub. No.: US 2024/0100462 A1
(43) Pub. Date: Mar. 28, 2024

(54) FOLDABLE FILTER ELEMENT AND FILTER WITH SAME

(71) Applicant: Dongguan JingNuo Environment Science and Technology Inc., Dongguan City (CN)

(72) Inventors: Rui CHEN, Dongguan City (CN); Zufeng LIN, Dongguan City (CN); Tianwen WU, Dongguan City (CN)

(21) Appl. No.: 17/984,585

(22) Filed: Nov. 10, 2022

(30) Foreign Application Priority Data
Sep. 23, 2022 (CN) 202222538637.9

(51) Int. Cl. B01D 46/52; B01D 46/00; B01D 46/14; B01D 46/24

(52) U.S. Cl. CPC B01D 46/522; B01D 46/0005; B01D 46/14; B01D 46/2403; B01D 2271/02

(57) ABSTRACT

The present disclosure relates to the technical field of filters, in particular to a foldable filter element, including a foldable filter assembly, a bottom setting end cover that is covered at a bottom end of the foldable filter assembly, a top setting end cover that is covered at an upper end of the foldable filter assembly, first sealing cotton arranged between the bottom setting end cover and the foldable filter assembly, and second sealing cotton arranged between the top setting end cover and the foldable filter assembly. The present disclosure has the characteristics of rational structure setting and effectively reducing the structure complexity and reducing the production cost. In addition, the present disclosure further provides a filter with the foldable filter element.

### TECHNICAL FIELD

The present disclosure relates to the technical field of filters, in particular to a foldable filter element and a filter with the same.

### BACKGROUND

An air filter refers to an air filtration device. With the increasingly severe air environment, people have more and more demands on the air filter at present; and during use, the air filter needs to replace the filter element to keep its filtering effect.

The packaging volume needs to be reduced when selling the filter product, because the common round or polylateral filter is installed in the random packaging of the filter when being sold for the first time, without influence on the packaging volume of the whole filter. However, when a consumer needs to replace the filter, the volume of the round or polylateral filter causes great packaging volume, and the cost is improved correspondingly. In order to overcome this defect, a foldable filter element is also researched, specifically refer to the patent application No. 202122110827.6, and the foldable filter element also has the defect of more complicated structure.

Therefore, it is urgent to provide a foldable filter element and a filter with the same to overcome the above defect.

### SUMMARY

The main purpose of the present disclosure is to provide a foldable filter element with the characteristics of rational structure setting and effectively reducing the structure complexity and reducing the production cost.

In order to implement the above purpose, the present disclosure adopts the technical solution below:

A foldable filter element, including a foldable filter assembly, a bottom setting end cover that is covered at a bottom end of the foldable filter assembly, a top setting end cover that is covered at a top end of the foldable filter assembly, first sealing cotton arranged between the bottom setting end cover and the foldable filter assembly, and second sealing cotton arranged between the top setting end cover and the foldable filter assembly;
the foldable filter assembly includes a filter element bracket and a filter paper element, wherein the filter element bracket is made and formed through polypropylene, the two ends of the filter element bracket are opened and the peripheral side is formed into a plurality of via holes, and the filter paper element is sleeved outside the filter element bracket;
the foldable filter assembly may be folded as a square shape or a circular shape.

Preferably, the sizes and intervals of the folded sides of the filter paper element are uniformly arranged around the periphery of the filter element bracket.

Preferably, at least a pair of folded thin wall sides is arranged on the side of the filter element bracket.

Preferably, the thickness of each folded thin wall side is less than that of a via hole side forming the via hole.

Preferably, the foldable filter assembly may be folded as a flat structure.

Preferably, the bottom setting end cover and the top setting end cover are formed into circular ring structures with first clamping grooves towards the sides of the bottom setting end cover and the top setting end cover.

Preferably, middles of the bottom setting end cover and the top setting end cover are formed into square structures with square slots, and the bottom setting end cover and the top setting end cover are formed into second clamping grooves towards the sides of the bottom setting end cover and the top setting end cover.

The present disclosure has the following beneficial effects: the filter paper element is sleeved outside the filter element bracket made and formed through polypropylene, the two ends of the foldable filter assembly are respectively fixed through the top setting end cover and the bottom setting end cover, so that the foldable filter assembly of the product has the detachable and foldable functions, thereby conveniently saving transportation space and reducing transportation cost. In addition, the foldable filter assembly of the product may be folded as the square shape or the circular shape, so the foldable filter assembly may be suitable for different models of filters by matching the corresponding top setting end cover and the bottom setting end cover, and the structure setting is reasonable and simple, so the production cost may be further controlled.

Correspondingly, the present disclosure further provides a foldable filter with the characteristics of rational structure setting and effectively reducing the structure complexity and reducing the production cost.

In order to implement the above purpose, the present disclosure adopts the technical solution below:

A filter with a foldable filter element, including an outer shell and a wind wheel mechanism arranged in the outer shell, further including a foldable filter element that is arranged in the outer shell, arranged at a lower end of the wind wheel mechanism and described as above.

By using the foldable filter element described as above, the filter with the foldable filter element provided by the present disclosure has the characteristics of rational structure setting and effectively reducing the structure complexity and reducing the production cost.

### BRIEF DESCRIPTION OF THE DRAWINGS

FIG. 1 is a structural schematic diagram of an embodiment of a foldable filter element in the present disclosure.

FIG. 2 is a breakdown schematic diagram of FIG. 1.

FIG. 3 is a folded schematic diagram of a foldable filter assembly of FIG. 1.

FIG. 4 is a structural schematic diagram of another embodiment of a foldable filter element in the present disclosure.

FIG. 5 is a breakdown schematic diagram of FIG. 4.

FIG. 6 is a folded schematic diagram of a foldable filter assembly of FIG. 4.

### REFERENCE SIGNS OF SPECIFICATION

1—Foldable filter assembly, 11—Filter element bracket, 111—Via hole, 112—Folded thin wall side, 12—Filter paper element, 2—Bottom setting end cover, 21—First clamping groove, 22—Square slot, 23—Second clamping groove, 3—Top setting end cover, 4—First sealing cotton, 5—Second sealing cotton.

### DETAILED DESCRIPTION OF THE EMBODIMENTS

In order to easily understand the technical means, creative features, achieved purposes and functions implemented by the present disclosure, the present disclosure is further described below in combination with the specific implementation modes.

It is to be noted that when one component is regarded to be “connected” or “arranged” on another component, this component may be directly or indirectly connected to other component.

In the description of the present disclosure, it is understood that orientation or position relationships indicated by the terms “upper”, “lower”, “front”, “rear”, “left”, “right”, “top” “bottom”, “inner”, “outer” and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure.

In addition, the terms “first” and “second” are merely used for description, instead of being understood as indicating or implying relative importance or impliedly indicating the quantity of the showed technical features. Thus, the features defined with “first” and “second” may expressly or impliedly one or more features. In the description of the present disclosure, “a plurality of” means two or above two, unless specific limitation otherwise. “a plurality of” means two or above two, unless specific limitation otherwise.

In the description of the present disclosure, it is noted that, unless specific regulation and limitation otherwise, terms “install”, “join” and “connect” should be generally understood, for example, may a fixed connection, a detachable connection, or integrated, may a mechanical connection or an electric connection, may a direct connection or an indirect connection through an intermediation, and may an internal connection of two elements or an interactive relationship of two elements. Those of ordinary skill in the art may understand the specific meaning of the terms in the disclosure according to specific conditions.

### Embodiment 1

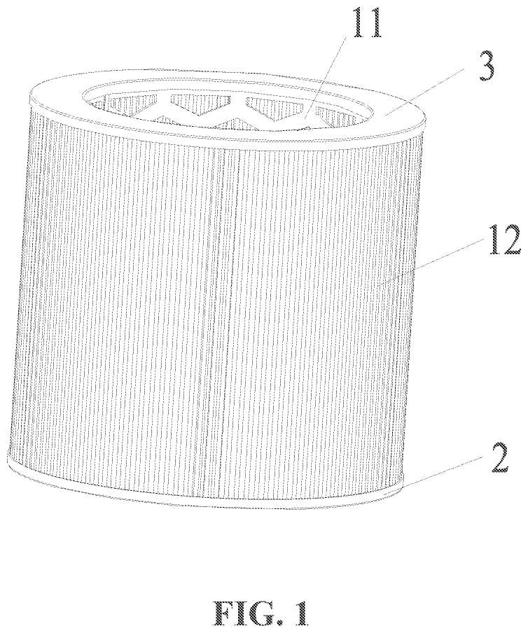

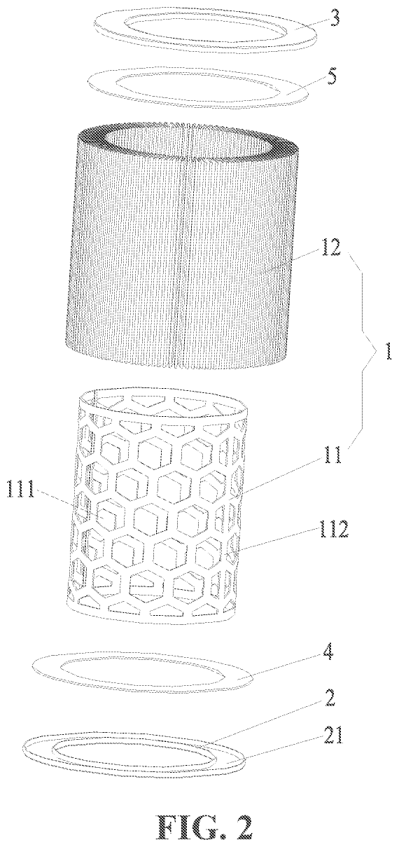

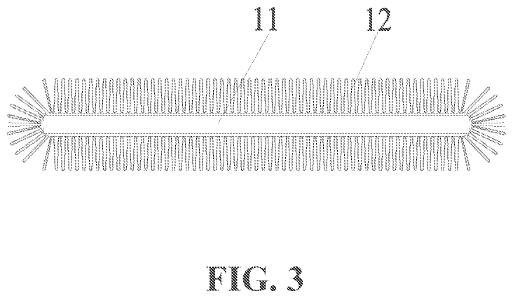

Please refer to FIG. 1 to FIG. 3, a foldable filter element of this embodiment includes a foldable filter assembly 1, a bottom setting end cover 2 that is covered at a bottom end of the foldable filter assembly 1, a top setting end cover 3 that is covered at a top of the foldable filter assembly 1, first sealing cotton 4 arranged between the bottom setting end cover 2 and the foldable filter assembly 1, and second sealing cotton 5 arranged between the top setting end cover 3 and the foldable filter assembly 1.

Specifically, the foldable filter assembly 1 includes a filter element bracket 11 and a filter paper element 12, wherein the filter element bracket 11 is made and formed through polypropylene, the two ends of the filter element bracket 11 are opened and the peripheral side is formed into a plurality of via holes 111, and the filter paper element 12 is sleeved outside the filter element bracket 11. The sizes and intervals of the folded sides of the filter paper element 12 are uniformly arranged around the periphery of the filter element bracket 11, at least a pair of folded thin wall sides 112 is arranged on the side of the filter element bracket 11, and the thickness of each folded thin wall side 112 is less than that of a via hole side forming the via hole 111. In this embodiment, the foldable filter assembly 1 may be folded as a circular shape, specifically the filter element bracket 11 is folded as a circular shape, and the foldable filter assembly 1 may be folded as a flat structure. The folded thin wall sides 112 are arranged, so that the filter element bracket 11 may be folded along each folded thin wall side 112, thereby improving the folding convenience. Each group of folded thin wall sides 112 is arranged in relative to each other, the filter element bracket 11 sleeved in the filter paper element 12 plays a role in supporting the filter paper element 12, and the use of the filter paper element 12 also helps fold the product. Further, the height of the filter element bracket 11 is consistent with that of the filter paper element 12. More further, the structural setting of the product also has the characteristic of replacing the filter paper element 12 conveniently, and the detachable setting mode of the filter paper element 12 and the filter element bracket 11 also further reduces the using cost of the product.

The bottom setting end cover 2 and the top setting end cover 3 are formed into circular ring structures with first clamping grooves 21 towards the sides of the bottom setting end cover 2 and the top setting end cover 3. After being clamped in the first sealing cotton 4 and the second sealing cotton 5, the first clamping grooves 21 are clamped at the two ends of the foldable filter assembly 1 so as to play a role in setting and fixing the foldable filter assembly 1. The first sealing cotton 4 and the second sealing cotton 5 are also circular.

In the present disclosure, the filter element bracket 11 is arranged in the foldable filter element through the filter paper element 12, so as to play a role in supporting the filter paper element 12. At the same time, the folded thin wall sides 112 are formed on the filter element bracket 11, and the polypropylene is used as the material, so as to increase the folding performance of the filter element bracket 11, and the product has the foldability, the transportation cost of the product is reduced, the product structure is simplified, the structural rationality of the product is improved, and then the production cost is reduced.

### Embodiment 2

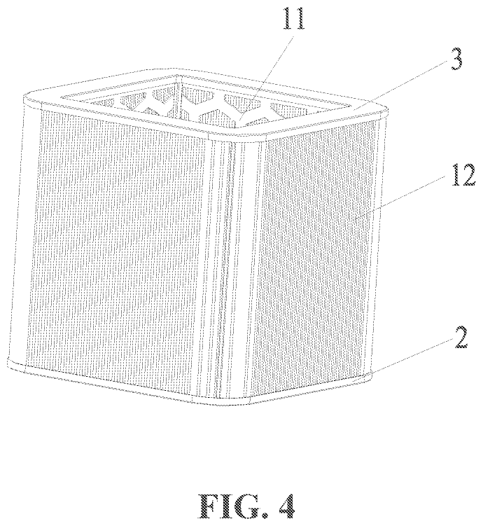

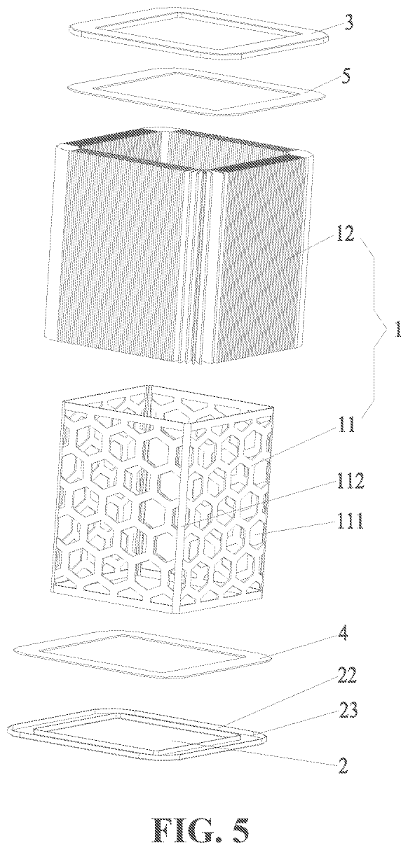

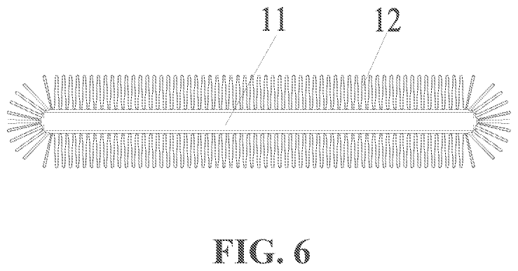

Then combine with FIG. 4 to FIG. 6, in some embodiments, the foldable filter assembly 1 is folded as a square shape, specifically the foldable filter assembly 1 may be folded as the square shape by folding the filter element bracket 11 and the filter paper element 12. At this time, middles of the bottom setting end cover 2 and the top setting end cover 3 are formed into square structures with square slots 22, and the bottom setting end cover 2 and the top setting end cover 3 are formed into second clamping grooves 23 towards the sides of the bottom setting end cover 2 and the top setting end cover 3. The two ends of the foldable filter assembly 1 folded as the square shape are padded into the first square sealing cotton 04 and the second square sealing cotton 05, and then clamped into the second clamping grooves 23 in respective. The bottom setting end cover 02 and the top setting end cover 03 are set and fixed, and the description of other structures may refer to the description of the above embodiments, and repetition is not made herein.

From the above description, it can be seen that the foldable filter element provided by the present disclosure may be folded as the square shape or the circular shape or other structures through the foldable filter assembly 1 formed by the filter paper element 12 and cooperating with the filter element bracket 11. In addition, the bottom setting end cover 02 and the top setting end cover 03 with the corresponding shape and structure are equipped, so that the product may be folded as the required using shape according to actual needs, and in addition, the product has the characteristics of rational structure setting, convenient transportation and effectively controlling the production cost.

### Embodiment 3

A filter with a foldable filter element in this embodiment, including an outer shell and a wind wheel mechanism arranged in the outer shell, further including a foldable filter element that is arranged in the outer shell, arranged at a lower end of the wind wheel mechanism and described as above. The outer shell and the wind wheel mechanism are all the application of the prior art, and please refer to the description of the above embodiments for the structure of the foldable filter element, and repetition is not made herein.

By using the foldable filter element, the filter of the product has the function of folding the filter element, and the characteristics of rational structure setting and effectively reducing the structure complexity and reducing the production cost.

The basic principles, main characteristics and advantages of the present disclosure are shown and described above. Those skilled in the art shall understand that the present disclosure is not limited by the above embodiments, the above embodiments and specification describe the principles of the present disclosure merely. Various changes and improvements will be made without deviating from the spirit and scope of the present the disclosure, and all of these fall within the scope of protection of the present disclosure. The scope of protection of the present disclosure is defined by the appended claims and their equivalents.

What is claimed is:

1. A foldable filter element, comprising a foldable filter assembly (1), a bottom setting end cover (2) that is covered at a bottom end of the foldable filter assembly (1), a top setting end cover (3) that is covered at a top end of the foldable filter assembly (1), first sealing cotton (4) arranged between the bottom setting end cover (2) and the foldable filter assembly (1), and second sealing cotton (5) arranged between the top setting end cover (3) and the foldable filter assembly (1);
the foldable filter assembly (1) comprises a filter element bracket (11) and a filter paper element (12), wherein the filter element bracket (11) is made and formed through polypropylene, the two ends of the filter element bracket (11) are opened and the peripheral side is formed into a plurality of via holes (111), and the filter paper element (12) is sleeved outside the filter element bracket (11); and
the foldable filter assembly (1) may be folded as a square shape or a circular shape.

2. The foldable filter element according to claim 1, wherein the sizes and intervals of the folded sides the filter paper element (12) are uniformly arranged around the periphery of the filter element bracket (11).

3. The foldable filter element according to claim 2, wherein at least a pair of folded thin wall sides (112) is arranged on the side of the filter element bracket (11).

4. The foldable filter element according to claim 3, wherein the thickness of each folded thin wall side (112) is less than that of a via hole side forming the via hole (111).

5. The foldable filter element according to claim 3, wherein the foldable filter assembly (1) may be folded as a flat structure.

6. The foldable filter element according to claim 1, wherein the bottom setting end cover (2) and the top setting end cover (3) are formed into circular ring structures with first clamping grooves (21) towards the sides of the bottom setting end cover (2) and the top setting end cover (3).

7. The foldable filter element according to claim 1, wherein middles of the bottom setting end cover (2) and the top setting end cover (3) are formed into square structures with square slots (22), and the bottom setting end cover (2) and the top setting end cover (3) are formed into second clamping grooves (23) towards the sides of the bottom setting end cover (2) and the top setting end cover (3).

8. The foldable filter element according to claim 2, wherein at least a pair of folded thin wall sides (112) is arranged on the side of the filter element bracket (11).

9. A filter with a foldable filter element, comprising an outer shell and a wind wheel mechanism arranged in the outer shell, wherein the filter further comprises a foldable filter element that is arranged in the outer shell, arranged at a lower end of the wind wheel mechanism and described in claim 1.
